(19) United States
(12) Patent Application Publication
(10) Pub. No.: US 2017/0278057 A1
(43) Pub. Date: Sep. 28, 2017

(54) INFORMATION PROCESSING APPARATUS, SHELF LABEL MANAGEMENT SYSTEM, CONTROL METHOD, AND PROGRAM

(71) Applicant: NEC Corporation, Minato-ku, Tokyo (JP)

(72) Inventors: Yoshihiro ITOU, Tokyo (JP); Kanako TAGA, Tokyo (JP); Takenobu KITAHARA, Tokyo (JP)

(73) Assignee: NEC Corporation, Minato-ku, Tokyo (JP)

(21) Appl. No.: 15/506,307

(22) PCT Filed: Sep. 28, 2015
(86) PCT No.: PCT/JP2015/077267

§ 371 Date: Feb. 24, 2017

(30) Foreign Application Priority Data
Sep. 30, 2014 (JP) 2014-201364

(51) Int. Cl. G06Q 10/08; G06K 9/00; G06K 19/06; G06K 9/32

(52) U.S. Cl. CPC G06Q 10/087; G06K 9/3241; G06K 9/00671; G06K 19/06103

(57) ABSTRACT

A product recognition unit (2020) recognizes a product from an image on which the product and an electronic shelf label are imaged (target image). A shelf label recognition unit (2040) extracts a shelf label ID of the electronic shelf label from the target image. The shelf label recognition unit (2040) recognizes a position of the electronic shelf label (3000) from the target image. A relation information generation unit (2060) generates relation information based on a position of the recognized product and the position of the recognized electronic shelf label (3000). The relation information associates product information of the recognized product with the shelf label ID of the recognized electronic shelf label (3000) closest to the product.

The present application claims priority based on Japanese Patent Application No. 2014-201364 filed on Sep. 30, 2014, and the entire content thereof is incorporated by reference in the present application.

### TECHNICAL FIELD

The present invention relates to an information processing apparatus, a shelf label management system, a control method, and a program.

### BACKGROUND ART

On a product shelving in a store, there is a shelf label near a product that describes information such as a name or price of the product (hereinafter, referred to as product information). In recent years, an electronic shelf label that displays product information on a small liquid crystal display is used.

In a case where the electronic shelf label is used, it is necessary to input the product information to the electronic shelf label. To do so, the product and the electronic shelf label are associated with each other. For example, Patent Document 1 discloses a technique for associating a product with an electronic shelf label by read a device code of the electronic shelf label and a product code of the product using a portable information acquisition terminal near the product.

### RELATED DOCUMENT

### Patent Document

[Patent Document 1] Japanese Patent Application Publication No. 2007-222645

### SUMMARY OF THE INVENTION

### Technical Problem

In a case where the technique described in Patent Document 1 is used, a salesperson needs to perform an operation of reading the device code of each electronic shelf label and the product code of each product into the information acquisition terminal. Thus, an effort and a time are required to associate the electronic shelf label with the product.

The invention has been made in view of the aforementioned problems. The present invention provides a technique for supporting an operation for displaying product information on an electronic shelf label.

### Solution to Problem

An information processing apparatus provided by the present invention includes: a product recognition unit recognizing a product from an image on which the product and an electronic shelf label are imaged; a shelf label recognition unit extracting a shelf label ID of the electronic shelf label from the image, and recognizing a position of the electronic shelf label; and a relation information generation unit generating relation information that associates product information of the recognized product with the shelf label ID of the recognized electronic shelf label closest to the product, based on a position of the recognized product and the position of the recognized electronic shelf label.

A shelf label management system provided by the present invention includes the information processing apparatus provided by the present invention and an electronic shelf label. The electronic shelf label includes a display unit displaying the product information associated with the shelf label ID of the electronic shelf label.

A control method provided by the present invention is performed by a computer. The control method includes: a product recognition step of recognizing a product from an image on which the product and an electronic shelf label are imaged; a shelf label recognition step of extracting a shelf label ID of the electronic shelf label from the image, and recognizing a position of the electronic shelf label; and a relation information generation step of generating relation information that associates product information of the recognized product with the shelf label ID of the recognized electronic shelf label closest to the product, based on a position of the recognized product and the position of the recognized electronic shelf label.

A program provided by the present invention causes a computer to have a function of operating as the information processing apparatus provided by the present invention.

### Advantageous Effects of Invention

According to the present invention, a technique for supporting an operation for displaying product information on an electronic shelf label is provided.

### BRIEF DESCRIPTION OF THE DRAWINGS

The above objects, other objects, advantages and features will be more apparent from the following description of certain preferred embodiments taken in conjunction with the accompanying drawings.

FIG. 1 is a block diagram illustrating an information processing apparatus according to Exemplary Embodiment 1 and a usage environment thereof.

FIG. 2 is a flowchart illustrating a flow of processes performed by the information processing apparatus of Exemplary Embodiment 1.

FIG. 3 is a block diagram illustrating a hardware configuration of a computer that realizes the information processing apparatus.

FIG. 4 is a diagram illustrating a target image.

FIG. 5 is a diagram illustrating product information including a feature value in a table format.

FIG. 6 is a diagram illustrating a predetermined area in which a shelf label ID is displayed.

FIG. 7 are diagrams illustrating an electronic shelf label that may be in two states.

FIG. 8 is a diagram illustrating a distance between a product and an electronic shelf label.

FIG. 9 is a diagram illustrating relation information in a table format.

FIG. 10 is a block diagram illustrating an information processing apparatus according to Exemplary Embodiment 2 and a usage environment thereof.

FIG. 11 is a flowchart illustrating a flow of processes performed by the information processing apparatus of Exemplary Embodiment 2.

FIG. 12 is a diagram illustrating a situation in which there is the electronic shelf label that is commonly closest from each of the plurality of different products.

FIG. 13 is a diagram illustrating a case where the electronic shelf label simultaneously displays two pieces of product information.

FIG. 14 is a diagram illustrating a case where the electronic shelf label displays three pieces of product information in a time-division manner.

FIG. 15 is a block diagram illustrating an information processing apparatus according to Exemplary Embodiment 3.

FIG. 16 is a flowchart illustrating a flow of processes performed by the information processing apparatus of Exemplary Embodiment 3.

FIG. 17 is a block diagram illustrating an information processing apparatus according to Exemplary Embodiment 4.

FIG. 18 is a diagram illustrating a case where the relation information is displayed on the target image.

FIG. 19 is a flowchart illustrating a flow of processes performed by the information processing apparatus of Exemplary Embodiment 4.

FIG. 20 is a block diagram illustrating an information processing apparatus according to Exemplary Embodiment 5.

FIG. 21 is a flowchart illustrating a flow of processes performed by the information processing apparatus of Exemplary Embodiment 5.

### DESCRIPTION OF EMBODIMENTS

Hereinafter, exemplary embodiments of the present invention will be described with reference to the drawings. In all the drawings, the same components will be assigned the same reference numerals, and the description thereof will not be appropriately repeated.

### Exemplary Embodiment 1

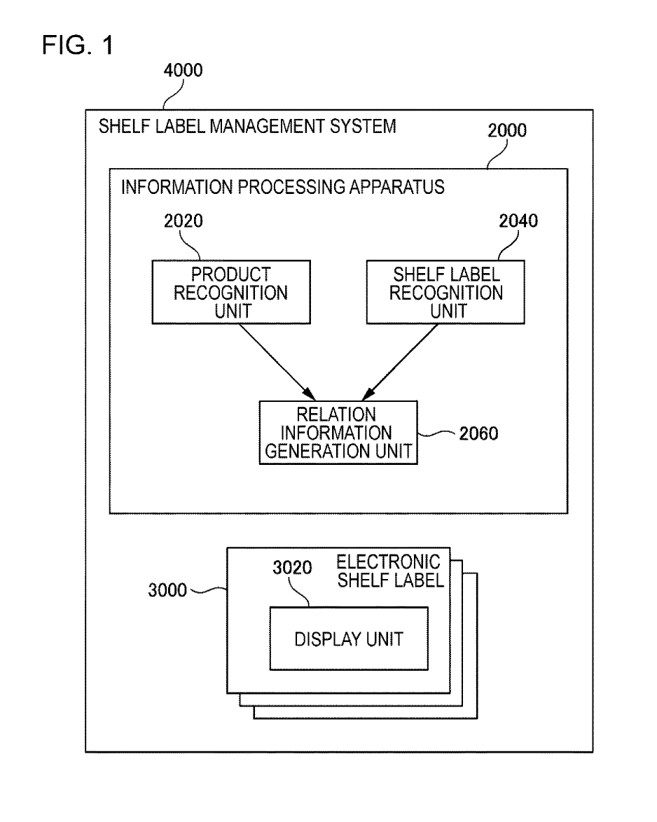

FIG. 1 is a block diagram illustrating an information processing apparatus 2000 according to Exemplary Embodiment 1 and a usage environment thereof. In FIG. 1, arrows represent information flows. In FIG. 1, each block depicts not a configuration of a hardware unit but a configuration of a functional unit.

The information processing apparatus 2000 is included in a shelf label management system 4000 with an electronic shelf label 3000. The electronic shelf label 3000 is a shelf label provided in the vicinity of a product (a shelf plate of product shelving), and displays product information. The product information displayed by the electronic shelf label 3000 includes, for example, a product name or price. The electronic shelf label 3000 includes a display unit 3020 that displays such the information. For example, the display unit 3020 is a liquid crystal display.

The information processing apparatus 2000 performs a process of associating the electronic shelf label 3000 with the product information. To do so, the information processing apparatus 2000 includes a product recognition unit 2020, a shelf label recognition unit 2040, and a relation information generation unit 2060. The product recognition unit 2020 recognizes a product from an image on which the product and the electronic shelf label 3000 are imaged (hereinafter, referred to as a target image). The shelf label recognition unit 2040 extracts the shelf label ID of the electronic shelf label from the target image. The shelf label recognition unit 2040 recognizes a position of the electronic shelf label 3000 from the target image. The relation information generation unit 2060 generates relation information based on a position of the product and a position of the electronic shelf label 3000. The relation information associates the product with the shelf label ID of the electronic shelf label 3000 closest to the product. Here, the product information includes a product ID that determines the product. The product is recognized by the product recognition unit 2020, and the shelf label ID is recognized by the shelf label recognition unit 2040.

<Flow of Processes>

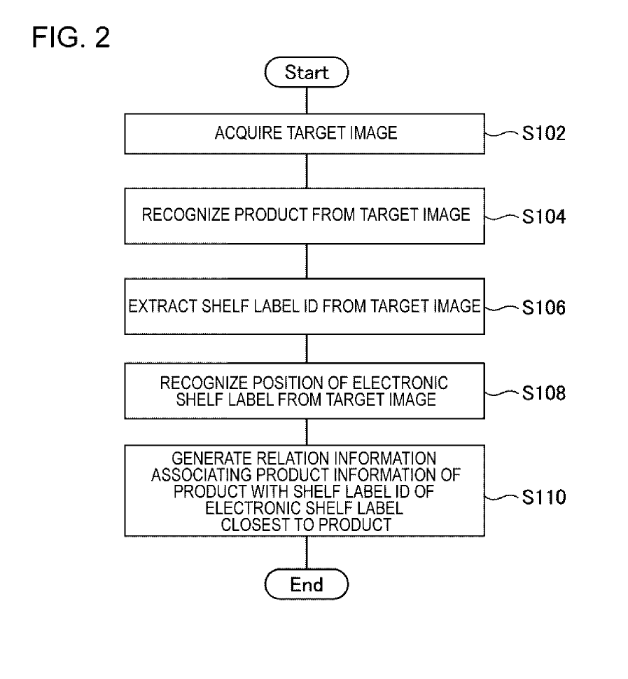

FIG. 2 is a flowchart illustrating a flow of processes performed by the information processing apparatus 2000 of Exemplary Embodiment 1. The information processing apparatus 2000 acquires the target image (S102). The product recognition unit 2020 recognizes the product from the target image (S104). The shelf label recognition unit 2040 extracts the shelf label ID of the electronic shelf label 3000 from the target image (S106). The shelf label recognition unit 2040 recognizes the position of the electronic shelf label 3000 from the target image (S108). The relation information generation unit 2060 generates the relation information (S110).

According to the information processing apparatus 2000 of the present exemplary embodiment, the product information of the product and the electronic shelf label 3000 closest to the product are associated with each other based on the target image on which the product and the electronic shelf label 3000 are pictured. Here, in general, a product name or price (product information) of a certain product is displayed on the electronic shelf label 3000 closest to the product. According to the information processing apparatus 2000 of the present exemplary embodiment, the product information and the electronic shelf label 3000 that displays the product information are automatically associated with each other using the target image. Thus, the salesperson does not need to perform an operation of reading each electronic shelf label 3000 or an ID of the product into an information acquisition terminal. Thus, the burden of work on the salesperson is reduced, and a time required to associate the electronic shelf label 3000 with the product information is reduced.

According to the information processing apparatus 2000 of the present exemplary embodiment, in a case where a plurality of different products and a plurality of different electronic shelf labels 3000 are pictured on the target image, a plurality of relation information is automatically generated. Thus, it is not necessary to generate pairs of the electronic shelf label 3000 and the product one by one. In this context, the burden of work on the salesperson is reduced, and the time required to associate the electronic shelf label 3000 with the product information is also reduced.

Hereinafter, the information processing apparatus 2000 of the present exemplary embodiment will be described in more detail.

<Hardware Configuration Example>

The respective functional components of the information processing apparatus 2000 may be realized by hardware that realizes each functional component (for example, a hard-wired electronic circuit), or may be realized by a combination of hardware and software (for example, a combination of an electronic circuit and a program that controls the electronic circuit). Hereinafter, in a case where each functional component is realized by the combination of hardware and software, the configuration thereof will be illustrated in detail.

The information processing apparatus 2000 is realized by various kinds of computers such as a portable terminal, a personal computer (PC), or a server. Here, the information processing apparatus 2000 may be realized by a dedicated computer for implementing the information processing apparatus 2000, or may be realized by a general-purpose computer that operates other applications.

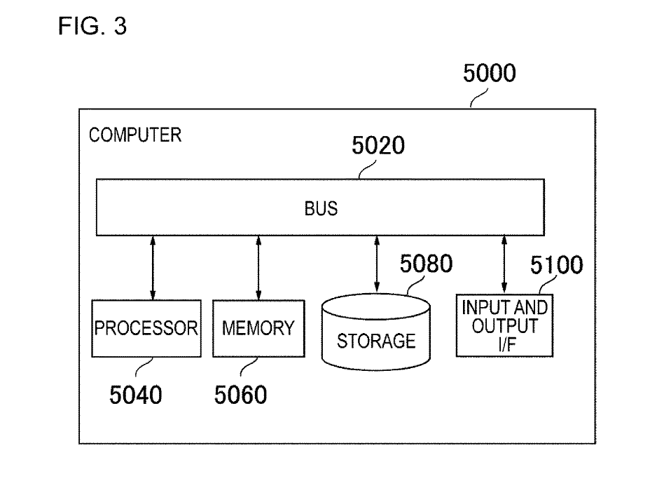

FIG. 3 is a block diagram illustrating a hardware configuration of a computer 5000 that realizes the information processing apparatus 2000. The computer 5000 includes a bus 5020, a processor 5040, a memory 5060, a storage 5080, and an input and output interface 5100. The bus 5020 is a data transmission path through which the processor 5040, the memory 5060, the storage 5080, and the input and output interface 5100 transmit and receive data to and from one another. Here, the method of connecting the processor 5040 and the like is not limited to bus connection. The processor 5040 is, for example, an arithmetic processing apparatus such as a central processing unit (CPU) or a graphics processing unit (GPU). The memory 5060 is, for example, a memory such as a random access memory (RAM) or a read only memory (ROM). The storage 5080 is, for example, a storage apparatus such as a hard disk, a solid state drive (SSD), or a memory card. The storage 5080 may be a memory such as RAM or ROM.

The input and output interface 5100 is an input and output interface through which the computer 5000 transmits and receives data to and from an external apparatus. For example, in a case where the information processing apparatus 2000 acquires the target image from the external apparatus or stores the generated relation information in the external apparatus, the computer 5000 that realizes the information processing apparatus 2000 is connected to the external apparatus through the input and output interface 5100. Note that there are various methods of connecting the computer 5000 to the external apparatus through the input and output interface. For example, such connection is bus connection using a bus line (for example, universal serial bus (USB)) or network connection using a network line. Note that the network line may be a wireless line, or may be a wired line.

The storage 5080 stores a program for realizing the function of the information processing apparatus 2000. Specifically, program modules for respectively realizing the functions of the product recognition unit 2020, the shelf label recognition unit 2040, and the relation information generation unit 2060 are stored. The processor 5040 realizes the functions of the product recognition unit 2020, the shelf label recognition unit 2040, and the relation information generation unit 2060 by executing the respective program modules. Here, when the respective modules are executed, the processor 5040 may read these modules into the memory 5060 and may execute the read module, or may execute the module without reading the module into the memory 5060.

The relation information generation unit 2060 may store the generated relation information in the storage 5080.

Note that, the hardware configuration of the computer 5000 used for realizing the information processing apparatus 2000 is not limited to the configuration illustrated in FIG. 3. For example, the respective program module may be stored in the memory 5060. In this case, the computer 5000 may not include the storage 5080.

<Acquisition Method of Target Image>

The target image is imaged by a camera provided in a store. Only one type of product may be pictured or a plurality of different products may be pictured on one target image.

For example, the information processing apparatus 2000 acquires the target image stored within this camera. In a case where the target image imaged by the camera is stored in an external storage apparatus, the information processing apparatus 2000 may acquire the target image from this storage apparatus. In another way, the camera may be configured to store the imaged target image in a storage apparatus provided within the information processing apparatus 2000. In this case, the information processing apparatus 2000 acquires the target image from a storage unit provided within the information processing apparatus 2000.

The camera may be provided integrally with the computer that realizes the information processing apparatus 2000, or may be provided outside that computer. As an example in which the camera is provided integrally with the computer that realizes the information processing apparatus 2000, there is a case where the information processing apparatus 2000 is realized by a portable terminal equipped with a camera. In this case, the information processing apparatus 2000 performs a process on a target image imaged by the camera of the portable terminal.

<Details of Product Recognition Unit 2020>

<<Method of Recognizing Product>>

The product recognition unit 2020 analyzes a target image, and recognizes a product. Here, a technique for recognizing an object such as a product pictured on an image is a well-known technique, and various known techniques may be used for recognizing the object. Hereinafter, an example of a process performed by the product recognition unit 2020 will be described.

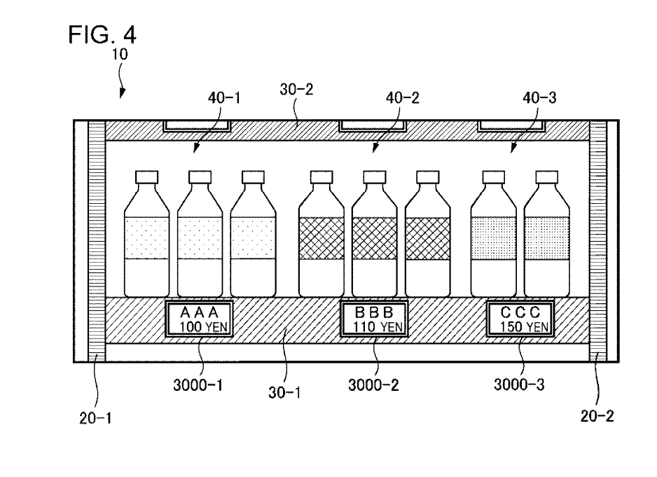

FIG. 4 is a diagram illustrating the target image. Product shelving on which the products are exhibited is pictured on the target image 10. Note that, an exhibition method of the products is not limited to a method of exhibiting the products on the product shelving, as long as the product and the electronic shelf label 3000 may be pictured on the target image.

An outer frame 20 is an outer frame of the product shelving. A shelf plate 30 is a plate on which the products are placed. The product 40 represents products. Three different products (product 40-1, product 40-2, and product 40-3) are pictured on the target image 10. The product 40-1 is Product AAA, the product 40-2 is Product BBB, and the product 40-3 is Product CCC. Three electronic shelf labels 3000 are pictured on the target image 10.

The product recognition unit 2020 recognizes each product by using information that associates the product with a feature value indicating an appearance feature of the product. For example, this information is included in the aforementioned product information. Here, the product information may be stored in advance in the storage unit provided inside or outside the information processing apparatus 2000. The product recognition unit 2020 acquires the product information from the storage unit.

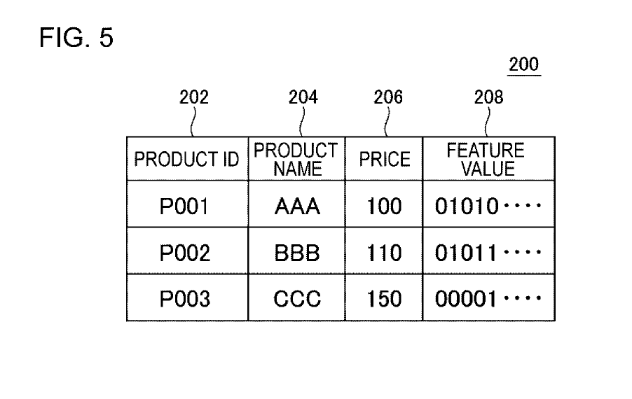

FIG. 5 is a diagram illustrating the product information including the feature value in a table format. The table illustrated in FIG. 4 is described as a product information table 200. The product information table 200 includes four columns of a product ID 202, a product name 204, a price 206, and a feature value 208. The product ID 202 is an ID of the product. The product name 204 represents a product name. The price 206 represents the price of the product. The feature value 208 is a value representing the appearance feature of the product.

Specifically, the product recognition unit 2020 extracts an area representing the product (product area) from the target image 10. The product recognition unit 2020 determines the product information having the feature value 208 that is equal or similar to the feature value of the extracted product area. The product recognition unit 2020 recognizes that the product represented by the extracted product area is the product determined by the product ID indicated by the acquired product information. The product recognition unit 2020 determines the product ID of the product represented by each product area by performing the aforementioned process on each product area.

Note that, a plurality of feature values may be associated with one product by the product information. In this case, these feature values are, for example, feature values indicating the features of the product viewed in different directions. In some products, the appearance of the product looks very different depending on directions in which the product is viewed. For example, a certain product would have patterns on the label attached thereto that look very different between when being viewed in a certain direction and when being viewed in another direction. Since the products are not necessarily placed to face to the same direction, when the appearance of the product looks very different depending on the directions in which the product is viewed, the feature values of the product extracted from the target image may be different even though the same product is viewed.

Thus, the product recognition unit 2020 acquires the product information of which at least one of the feature values indicated by the plurality of feature values 208 is equal or similar to the feature value of the product area extracted from the target image 10. The product recognition unit 2020 recognizes that the product represented by this product area is the product specified by the acquired product information. Through such processes, for example, even in a case where the products, the appearances of which look very different depending on the directions in which the products are viewed, are exhibited in an arbitrary direction, it is possible to correctly recognize the products pictured on the target image.

<<Method of Recognizing Position of Product>>

For example, the product recognition unit 2020 recognizes a coordinate on the target image 10 of the area representing a group of the adjacent same products 40 (hereinafter, referred to as a product group area), as a position of the product 40. Note that, the number of products included in the product group area may be one.

The coordinate of the product group area is a coordinate indicating a predetermined location within the product group area defined in advance. For example, this predetermined location is a center, a left end, or a right end of an area indicating the product group area. The predetermined location to be handled as the location of the product area is set for the product recognition unit 2020 in advance. The product recognition unit 2020 may recognize a plurality of positions of the product 40. Specifically, the product recognition unit recognizes a position of the left end, a position of the center, or a position of the right end of the product group area of each product 40. Note that, the product recognition unit 2020 may represent the position of the product 40 as a two-dimensional coordinate (a combination of a coordinate in a horizontal direction with a coordinate in a vertical direction), or may represent the position thereof as a one-dimensional coordinate (a coordinate in the horizontal direction).

<Details of Shelf Label Recognition Unit 2040>

<<Extraction Method of Shelf Label ID>>

The shelf label recognition unit 2040 analyzes the target image, and extracts the ID of the electronic shelf label 3000. Here, the shelf label ID for identifying the electronic shelf label 3000 is displayed on the electronic shelf label 3000. The shelf label recognition unit 2040 extracts the shelf label ID of the electronic shelf label 3000 displayed by the electronic shelf label 3000.

Initially, the shelf label recognition unit 2040 extracts an area representing the electronic shelf label 3000 (hereinafter, referred to as a shelf label area) from the target image. Here, the process of extracting the shelf label area from the target image may be realized by an existing technique of object recognition like the process of extracting the product area from the target image. For example, the shelf label recognition unit 2040 recognizes the electronic shelf label 3000 by acquiring information indicating a feature value of the electronic shelf label 3000 and recognizing an object that matches this feature value from the target image. Here, the feature value of the electronic shelf label 3000 may be stored in advance in the storage unit provided inside or outside the information processing apparatus 2000.

For example, the shelf label recognition unit 2040 recognizes an area in which the electronic shelf label 3000 is provided (shelf plate 30 or the like), and recognizes an object having a predetermined shape (a rectangle or the like) included in this area, as the electronic shelf label 3000. Here, the predetermined shape representing the electronic shelf label 3000 or the feature value of the shelf plate 30 may be set for the shelf label recognition unit 2040 in advance, or may be stored in the storage unit inside or outside the information processing apparatus 2000.

The shelf label recognition unit 2040 extracts the area representing the shelf label ID from the shelf label area. The shelf label recognition unit 2040 acquires the shelf label ID by analyzing this area.

Here, the process of acquiring the shelf label ID by analyzing the area representing the shelf label is different depending on a display format of the shelf label ID. For example, the shelf label ID displayed on the electronic shelf label 3000 may be a character string that directly represents the shelf label ID, another character string converted from the shelf label ID, or a figure such as a two-dimensional code or a barcode converted from the shelf label ID. Note that, the “another character sting converted from the shelf label ID” is, for example, a character string acquired by encrypting the shelf label ID.

In a case where the shelf label ID is displayed by a character string, the shelf label recognition unit 2040 acquires a character string displayed on the electronic shelf label 3000 by performing character string analysis on the area representing the shelf label ID. Here, in a case where the character string displayed on the electronic shelf label 3000 represents directly the shelf label ID, the shelf label recognition unit 2040 uses the acquired character string as the shelf label ID. On the other hand, in a case where the character string displayed on the electronic shelf label 3000 is the character string converted from the shelf label ID, the shelf label recognition unit 2040 calculates the shelf label ID by performing a predetermined reverse-conversion process on the acquired character string. The predetermined reverse-conversion process is a process of decoding the encoded character string. The content of the predetermined reverse-conversion process may be set for the shelf label recognition unit 2040 in advance, or may be stored in the storage unit inside or outside the information processing apparatus 2000 in advance.

In a case where the shelf label ID is displayed by the figure such as the aforementioned two-dimensional code, the shelf label recognition unit 2040 extracts the figure from the target image. The shelf label recognition unit 2040 calculates the shelf label ID from the extracted figure. Here, the technique for calculating a value represented by the figure from the figure such as the two-dimensional code or the barcode is a well-known technique, and thus, the description thereof will not be repeated.

<<Method for Distinguishing Display from Another Display>>

Here, in some cases, something other than the character string representing the shelf label ID may also be displayed on the electronic shelf label 3000. For example, in some cases, a product name or price may be previously displayed on the electronic shelf label 3000. In such a case, a location of the electronic shelf label 3000 in which the shelf label ID will be displayed may be defined in advance.

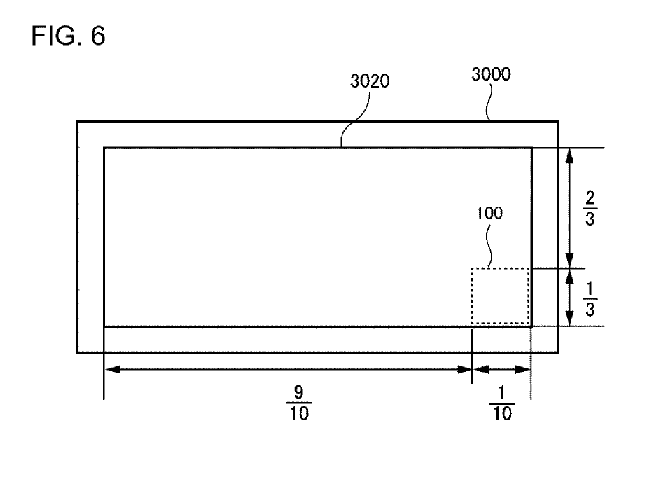

FIG. 6 is a diagram illustrating a predetermined area in which the shelf label ID is displayed. In FIG. 6, a horizontal range of an area 100 displaying the shelf label ID is “a range between the right end and a position distant from the right end by a distance of a tenth shorter than a long side of the electronic shelf label 3000”. A vertical range of the area displaying the shelf label ID is “a range between the lower end and a position distant from the lower end by a distance of a third shorter than a short side of the electronic shelf label 3000”. In this case, the shelf label recognition unit 2040 extracts the shelf label ID by extracting the area 100 of the electronic shelf label 3000 from the target image.

The electronic shelf label 3000 may be configured so as to be able to become in 1) a state in which the product information is displayed and 2) in a state in which the shelf label ID of the electronic shelf label 3000 is displayed. Here, the state in which the product information is displayed is referred to as a first mode, and the state in which the shelf label ID is displayed is referred to as a second mode.

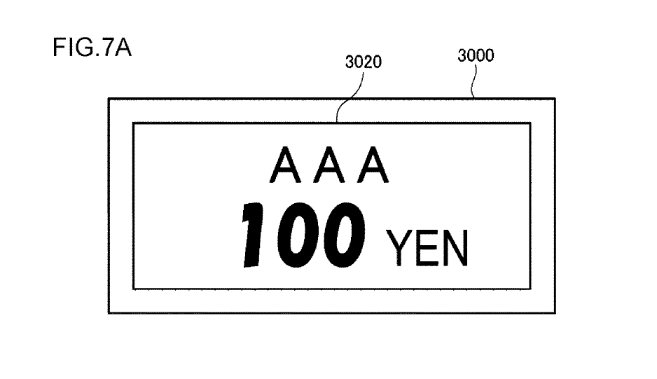

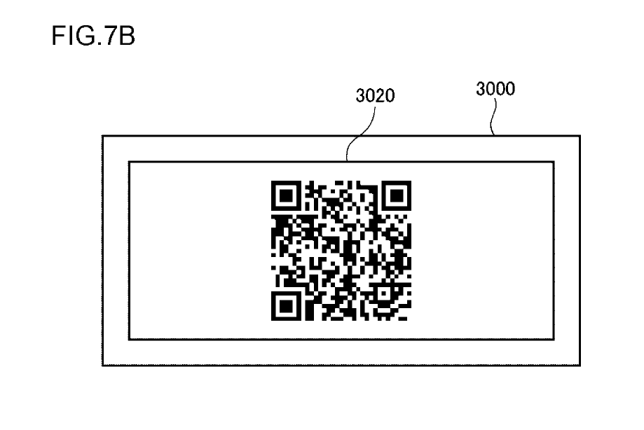

FIG. 7 are diagrams illustrating the electronic shelf label 3000 that may be in two states. FIG. 7A is a diagram illustrating the electronic shelf label 3000 in the first mode. In this diagram, the display unit 3020 displays the product name and price. On the other hand, FIG. 7B is a diagram illustrating the electronic shelf label 3000 in the second mode. In this diagram, the display unit 3020 displays the two-dimensional code representing the shelf label ID.

The information processing apparatus 2000 uses the target image on which the electronic shelf label 3000 in the second mode is imaged. By doing so, unnecessary character strings are not displayed on the display unit 3020, and it therefore makes easy the extraction process of the shelf label ID performed by the shelf label recognition unit 2040. The shelf label ID is able to be displayed with a larger size than that in a case where the product information is always displayed on the display unit 3020. Thus, it is possible to suppress a resolution required for the camera that images the target image. In addition, the product information is able to be displayed with a larger size than that in a case where the shelf label ID is always displayed on the display unit 3020. Thus, the product information is able to be easily viewed.

<<Method of Recognizing Position of Electronic Shelf Label 3000>>

For example, the shelf label recognition unit 2040 recognizes the coordinate of the electronic shelf label 3000 on the target image 10, as the position of the electronic shelf label 3000. The method of recognizing the coordinate of the electronic shelf label 3000 on the target image 10 is the same as the method of causing the product recognition unit 2020 to recognize the coordinate of the product group area.

<Details of Relation Information Generation Unit 2060>

<<Method of Determining Associated Product 40 with Electronic Shelf Label 3000>>

The relation information generation unit 2060 associates the product information of a certain product 40 with the electronic shelf label 3000 closest to the product 40. Here, the “nearest electronic shelf label 3000” is the electronic shelf label 3000 the distance from the product 40 of which is the closest. For example, the relation information generation unit 2060 calculates the distance between the product 40 and each electronic shelf label 3000. The relation information generation unit 2060 handles the electronic shelf label 3000 the calculated value of which is the smallest, as the closest electronic shelf label 3000 of the product 40.

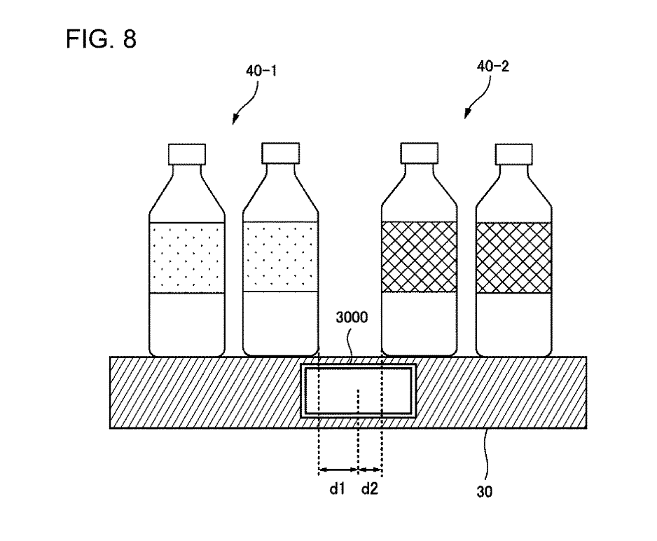

For example, the relation information generation unit 2060 calculates the distance between the product 40 and the electronic shelf label 3000, as a length between the position of the product 40 and the position of the electronic shelf label 3000. Here, in a case where the product recognition unit 2020 recognizes the plurality of positions of the product as stated above, the relation information generation unit 2060 may cause the position of the product 40 used for calculating the distance between the product 40 and the electronic shelf label 3000 to be different based on the positional relationship between the product 40 and the electronic shelf label 3000. FIG. 8 is a diagram illustrating the distance between the product 40 and the electronic shelf label 3000. In FIG. 8, the product 40-1 is located on the left side of the electronic shelf label 3000. Thus, the relation information generation unit 2060 calculates a distance d1 between the product 40-1 and the electronic shelf label 3000, as a distance of a coordinate of the right end of the product group area of the product 40-1 and a coordinate of the center of the electronic shelf label 3000. On the other hand, the product 40-2 is located on the right side of the electronic shelf label 3000. Thus, the relation information generation unit 2060 calculates a distance d2 between the product group area of the product 40-2 and the electronic shelf label 3000, as a distance between a coordinate of the left end of the product group area of the product 40-2 and a coordinate of the center of the electronic shelf label 3000.

Note that, in a case where a plurality of rows of the product shelving is pictured on the target image, the relation information generation unit 2060 may take into account which product 40 and which electronic shelf label 3000 are included in the same row. Specifically, the relation information generation unit 2060 limits the electronic shelf label 3000, which is handled as a determination target of whether or not the electronic shelf label is closest to the product 40, to the electronic shelf label 3000 included in the same row as this product 40.

Although it has been described in FIG. 4 that the product 40 associated with the electronic shelf label 3000 is placed on the shelf plate 30, an exhibition method of placing the product 40 associated with the electronic shelf label 3000 under the shelf plate 30 is also used. That is, a certain row of the product shelving becomes 1) an area including the shelf plate 30 and the product 40 placed on the shelf plate 30 or 2) an area including the shelf plate 30 and the product 40 placed under the shelf plate 30. Whether the relation information generation unit 2060 recognizes 1) or 2) as the row is set in advance. For example, information for determining whether the determination unit recognizes 1) or 2) as the row (information indicating whether the electronic shelf label 3000 is attached above or under the product 40) is stored in advance in the storage unit provided inside or outside the information processing apparatus 2000. The relation information generation unit 2060 determines an area recognized as one row by referring to this information. The relation information generation unit 2060 associates the product information of the product 40 included in the same row with the electronic shelf label 3000.

<<Details of Relation Information>>

After the electronic shelf label 3000 closest to the product 40 is determined, the relation information generation unit 2060 generates the relation information by associating the product information of the product 40 with the shelf label ID of the determined electronic shelf label 3000. Here, as mentioned above, the product ID of each product pictured on the target image is acquired by the product recognition unit 2020. Thus, the relation information generation unit 2060 associates the product ID of the product 40 with the shelf label ID of the electronic shelf label 3000 closest to the product 40. Here, the product information indicated by the relation information may include an attribute such as a product name.

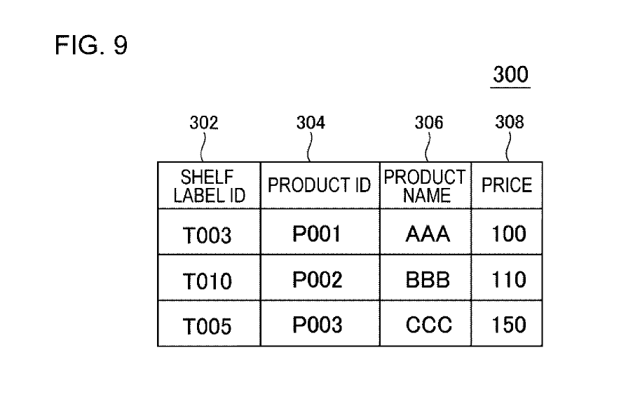

FIG. 9 is a diagram illustrating the relation information in a table format. The table of FIG. 9 is described as a relation information table 300. The relation information table 300 includes four columns: a shelf label ID 302; a product ID 304; a product name 306; and a price 308. The shelf label ID 302 is the shelf label ID of the electronic shelf label 3000. The product ID 304, the product name 306, and the price 308 are equivalent to the product ID 202, the product name 204, and the price 206 of the product information table 200.

<Timing when Information Processing Apparatus 2000 Performs Processes>

There are various timings when the information processing apparatus 2000 performs the series of processes. For example, the information processing apparatus 2000 periodically performs the processes. In this case, for example, a date and time or a cycle in which the process is performed is set in advance for the information processing apparatus 2000. In another example, the information processing apparatus 2000 may perform the process when the operation of the salesperson is received. In addition, the information processing apparatus 2000 may perform the process when the target image is generated or when the target image is acquired.

For example, suppose that the electronic shelf label 3000 transitions from the aforementioned first mode (the state in which the product information is displayed) to the second mode (the state in which the shelf label ID is displayed) at a cycle such as once every hour and transitions to the first mode again after several seconds. In this case, the target image on which the electronic shelf label 3000 on which the shelf label ID is displayed is pictured is imaged at the aforementioned cycle. In this case, for example, the information processing apparatus 2000 performs the process at the aforementioned cycle. By doing this, the product information may be periodically set to the electronic shelf label 3000.

<Method of Causing Electronic Shelf Label 3000 to Acquire Product Information>

For example, the electronic shelf label 3000 acquires the relation information associated with the shelf label ID of the electronic shelf label 3000 from the storage unit that stores the relation information generated by the relation information generation unit 2060. Here, the method of causing the electronic shelf label 3000 to acquire the product information is not limited to this method. Another method of causing the electronic shelf label 3000 to acquire the product information will be described in the following exemplary embodiment.

### Exemplary Embodiment 2

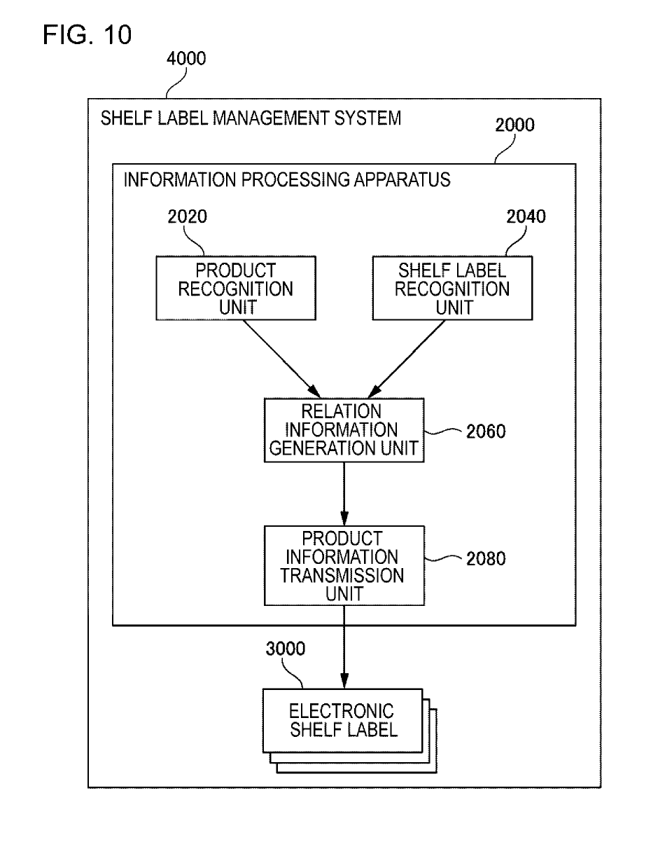

FIG. 10 is a block diagram illustrating an information processing apparatus 2000 according to Exemplary Embodiment 2 and a usage environment thereof. In FIG. 10, arrows represent information flows. In FIG. 10, each block does not depict a configuration of a hardware unit but a configuration of a functional unit. Except for the following description, the information processing apparatus 2000 of Exemplary Embodiment 2 has the same configuration as that of the information processing apparatus 2000 of Exemplary Embodiment 1.

The information processing apparatus 2000 of Exemplary Embodiment 2 includes a product information transmission unit 2080. The product information transmission unit 2080 transmits the product information to the electronic shelf label 3000 by using the relation information generated by the relation information generation unit 2060. Here, the product information transmitted to the electronic shelf label 3000 from the product information transmission unit 2080 is product information associated with the electronic shelf label 3000 in the relation information generated by the relation information generation unit 2060.

For example, the product information transmission unit 2080 transmits the product information to the electronic shelf label 3000 by using infrared communication. Here, the method of causing the product information transmission unit 2080 to transmit the product information is not limited to the method using the infrared communication. There are various well-known techniques of transmitting information to the electronic shelf label 3000, and the product information transmission unit 2080 may transmit the information to the electronic shelf label 3000 by using these well-known techniques.

As stated above, the display unit 3020 displays the received product information. For example, the display unit 3020 displays the product name and the price indicated by the product information. Note that, the information displayed on the display unit 3020 may be a part or whole of the received product information. In addition, the product information transmitted from the product information transmission unit 2080 to the electronic shelf label 3000 may be apart or whole of the product information associated with the electronic shelf label 3000. For example, the product information transmission unit 2080 transmits to the electronic shelf label 3000 only the price and the product name among pieces of information included in the product information.

<Flow of Processes>

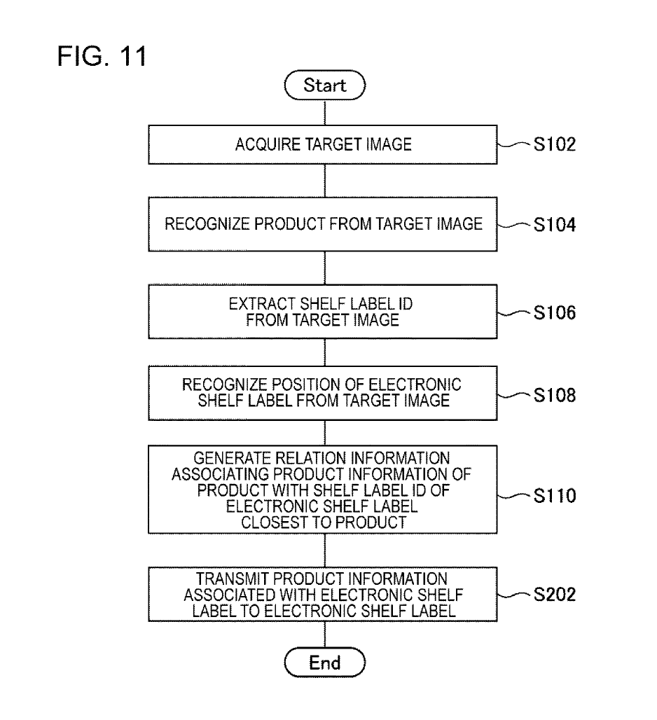

FIG. 11 is a flowchart illustrating a flow of processes performed by the information processing apparatus 2000 of Exemplary Embodiment 2. Here, the processes in steps S102 to S110 of FIG. 11 are the same as the processes performed in steps S102 to S110 of FIG. 2. Thus, the description of these processes will not be repeated.

After step S110 is performed, the product information transmission unit 2080 transmits the product information associated with the electronic shelf label 3000 to the electronic shelf label 3000.

<Timing when Product Information Transmission Unit 2080 Operates>

There are various timings when the product information transmission unit 2080 operates. For example, the product information transmission unit 2080 transmits the product information when the relation information generation unit 2060 generates the relation information, as illustrated in FIG. 11. However, a timing when the product information transmission unit 2080 operates is not limited to the timing illustrated in FIG. 11. For example, the product information transmission unit 2080 operates at a predetermined cycle. In this case, for example, the product information transmission unit 2080 transmits the product information for all pieces of the relation information that are generated from the previous operation to the current operation. In another example, the product information transmission unit 2080 may operate when the operation of the salesperson is received.

According to the present exemplary embodiment, the product information is transmitted to the electronic shelf label 3000 by using the relation information generated by the relation information generation unit 2060. For example, if the product information is not set for the electronic shelf label 3000, the product information is newly set for the electronic shelf label 3000. As a concrete example of usage, there is a case where the information processing apparatus 2000 operates after the products are exhibited and the electronic shelf label 3000 is placed in a required location. By doing so, the product information is automatically set for each electronic shelf label 3000 by using the analyzed result of the target image. Thus, the effort and the time required to set the product information for the electronic shelf label 3000 are reduced.

In another example, if the product information is already set for the electronic shelf label 3000, the product information set for the electronic shelf label 3000 is updated. For example, in a case where the product is replaced, the newly placed product and the product information displayed on the electronic shelf label 3000 placed before the replacement become not being relevant to each other. According to the information processing apparatus 2000 of the present exemplary embodiment, since the product information is transmitted to the electronic shelf label 3000 based on the analyzed result of the target image, the content displayed on the electronic shelf label 3000 is updated with information related to the replaced product. Thus, the effort and the time such as the replaced operation of the product are reduced.

<Handling in Case where Plurality of Different Products 40 is Associated with Electronic Shelf Label 3000>

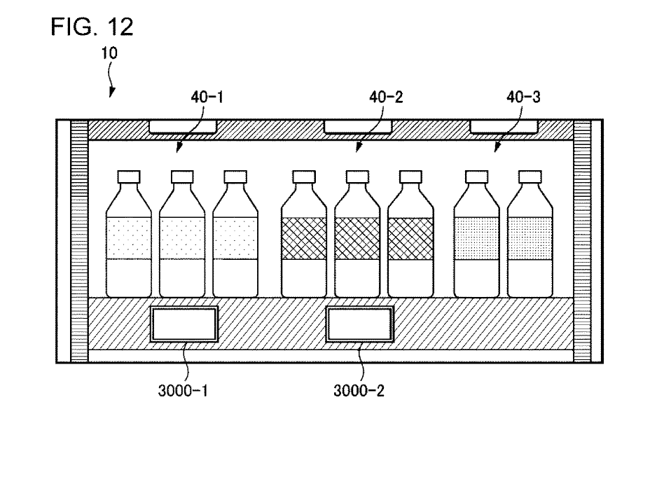

There could be the electronic shelf label that is commonly closest from each of a plurality of products 40. FIG. 12 is a diagram illustrating a situation in which there is the electronic shelf label 3000 that is commonly closest from each of the plurality of different products 40. In FIG. 12, both the electronic shelf label 3000 closest to the product 40-2 and the electronic shelf label 3000 closest to the product 40-3 are the electronic shelf label 3000-2.

For example, the relation information generation unit 2060 associates the product information of each product 40 with the shelf label ID of the closest electronic shelf label 3000 even in such a situation. In FIG. 12, the relation information generation unit 2060 generates both 1) the relation information associating the product information of the product 40-2 with the electronic shelf label 3000-2 and 2) the relation information associating the product information of the product 40-3 with the electronic shelf label 3000-2.

In this case, for example, the product information transmission unit 2080 transmits to one electronic shelf label 3000 the plurality of pieces of product information associated with this electronic shelf label 3000. In FIG. 12, the product information transmission unit 2080 transmits both the product information of the product 40-2 and the product information of the product 40-3 to the electronic shelf label 3000-2. As examples of the display performed by the electronic shelf label 3000 that receives the plurality of pieces of product information as stated above, there are two examples to be described below.

<<Plurality of Product Information is Simultaneously Displayed>>

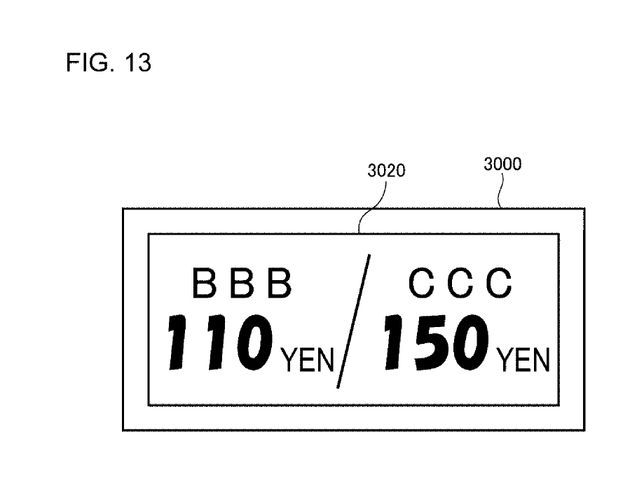

In the first example, the electronic shelf label 3000 simultaneously displays the plurality of pieces of the received product information. FIG. 13 is a diagram illustrating a case where the electronic shelf label 3000 simultaneously displays two pieces of product information. The electronic shelf label 3000 displays the product information of the product 40 placed on the left side on the left side of the display unit 3020, and the product information of the product 40 placed on the right side on the right side of the display unit 3020.

<<Plurality of Pieces of Product Information are Displayed in Time-Division Manner>>

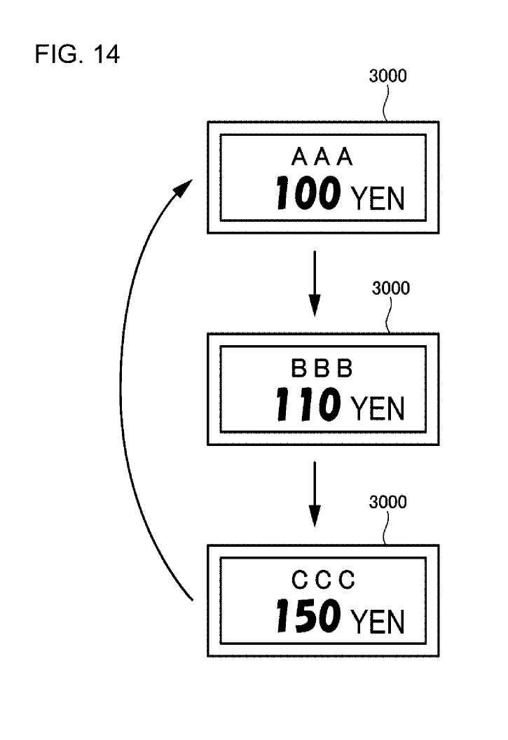

In the second example, the electronic shelf label 3000 displays the plurality of pieces of the received product information in a time-division manner. FIG. 14 is a diagram illustrating a case where the electronic shelf label 3000 displays three pieces of product information in a time-division manner. The electronic shelf label 3000 may sequentially change the display of the display unit 3020 in the order of 1) the product information of Product AAA, 2) the product information of Product BBB, 3) the product information of Product CCC, 4) the product information of Product AAA . . . .

As the situation in which the plurality of different pieces of product information is associated with the same electronic shelf label 3000 as stated above, there is a situation in which there is not enough of electronic shelf label 3000. For example, the situation of FIG. 12 is a situation in which the electronic shelf label 3000 should be placed under the product 40-3. By displaying the plurality of pieces of product information on the electronic shelf label 3000 in a simultaneous or time-division manner as stated above, the product information of all the products are displayed on the electronic shelf label 3000 in such the situation in which there is not enough of electronic shelf label 3000. Thus, a customer can recognize the product information of each product.

Note that, the information processing apparatus 2000 may have a function of performing the notification to the salesperson in a case where the plurality of pieces of product information is associated with the electronic shelf label 3000. The salesperson performs an operation of adding the electronic shelf label 3000 in response to receive this notification. In this case, the electronic shelf label 3000 displays the plurality of pieces of product information as a temporary action until the salesperson performs the operation of adding the electronic shelf label 3000.

Here, in a case where the electronic shelf label 3000 is configured to “display the recently received product information”, it is considered that only the recently transmitted product information is displayed on the electronic shelf label 3000 even though the plurality of pieces of product information are transmitted to one electronic shelf label 3000. Thus, for example, in a case where the plurality of pieces of product information are to be displayed on the electronic shelf label 3000, the product information transmission unit 2080 transmits a flag indicating that the plurality of pieces of product information are to be displayed on the electronic shelf label together with the product information, to the electronic shelf label 3000. The electronic shelf label 3000 is configured to display all the plurality of pieces of product information received together with the flag, in a simultaneous or time-division manner.

### Exemplary Embodiment 3

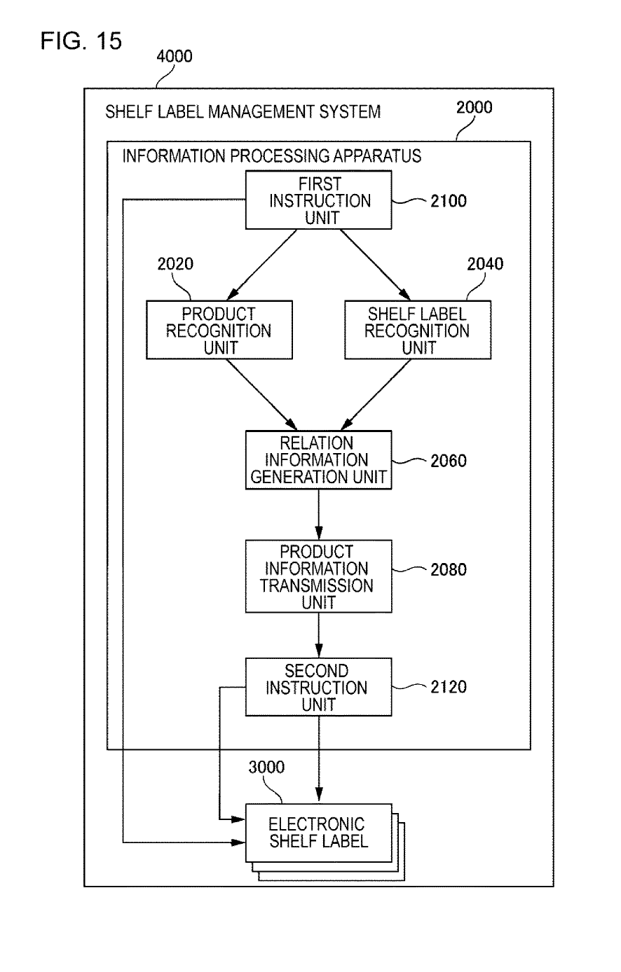

FIG. 15 is a block diagram illustrating an information processing apparatus 2000 according to Exemplary Embodiment 3. In FIG. 15, arrows represent information flows. In FIG. 15, each block does not depict a configuration of a hardware unit but a configuration of a functional unit. Except for the following description, the information processing apparatus 2000 of Exemplary Embodiment 3 has the same configuration as that of the information processing apparatus 2000 of Exemplary Embodiment 2.

In Exemplary Embodiment 3, the electronic shelf label 3000 may be in two states of the aforementioned first mode and second mode. The information processing apparatus 2000 of Exemplary Embodiment 3 transmits an instruction to switch two states to the electronic shelf label 3000. To do so, the information processing apparatus 2000 includes a first instruction unit 2100, and a second instruction unit 2120.

The first instruction unit 2100 transmits an instruction to switch from the first mode to the second mode (hereinafter, referred to as a first instruction) to the electronic shelf label 3000. The electronic shelf label 3000 that receives the first instruction transitions from the first mode to the second mode. The second instruction unit 2120 transmits an instruction to switch from the second mode to the first mode (hereinafter, referred to as a second instruction) to the electronic shelf label 3000. The electronic shelf label 3000 that receives the second instruction transitions from the second mode to the first mode.

Here, when transmitting the instruction, the first instruction unit 2100 and the second instruction unit 2120 may transmits the instruction to all the electronic shelf labels 3000, or may transmit the instruction to only determined shelf labels 3000. For example, in a case where the product information is desired to be set for all the electronic shelf labels 3000 at the same time or in a case where it is not able to determine the electronic shelf labels 3000 for which the product information is desired to be set, the first instruction unit 2100 and the second instruction unit 2120 transmit the instruction to all the electronic shelf labels 3000 at the same time. On the other hand, in a case where the electronic shelf label 3000 for which the product information is desired to be set is determined, the first instruction unit 2100 and the second instruction unit 2120 may transmit the instruction to only the determined electronic shelf label 3000. For example, as the situation in which the determined electronic shelf label 3000 is used as the target, there is a case where new products are exhibited and the electronic shelf label 3000 is accordingly added to under the products.

<Flow of Processes>

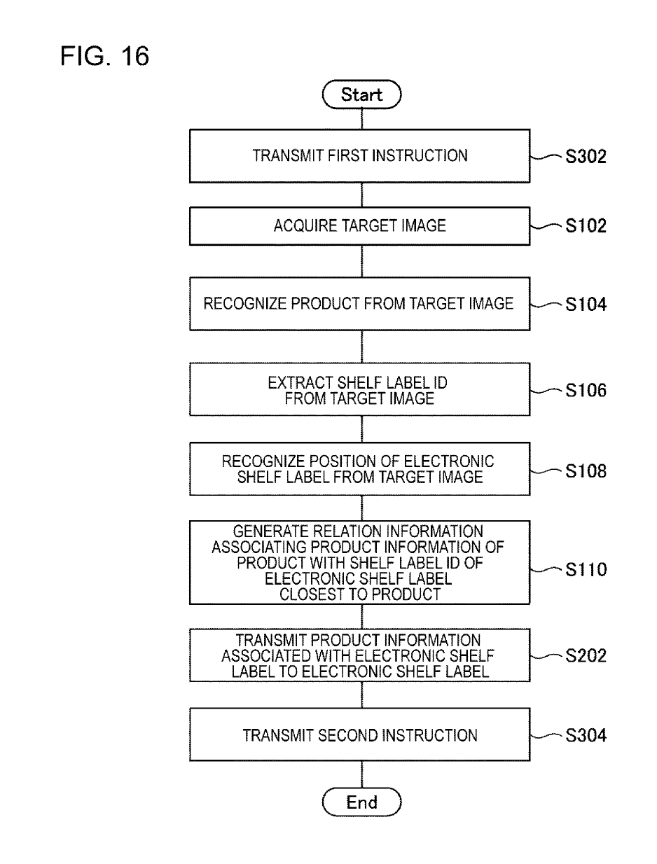

The information processing apparatus 2000 of Exemplary Embodiment 3 uses the target image on which the electronic shelf label 3000 in the second mode is imaged. Thus, for example, the information processing apparatus 2000 of Exemplary Embodiment 3 performs processes according a flow indicated by the flowchart of FIG. 16. Here, the processes in steps S102 to S110 and S202 of FIG. 16 are the same as the processes performed in steps S102 to S110 and S202 of FIG. 11. Thus, the description of these processes will not be repeated.

Initially, the first instruction unit 2100 transmits the first instruction to the electronic shelf label 3000 (S302). As a result, the electronic shelf label 3000 displays the shelf label ID. Thereafter, the processes of step S102 to S110 and step S202 are performed. After the product information transmission unit 2080 transmits the product information, the second instruction unit 2120 transmits the second instruction to the electronic shelf label 3000. As a result, the product information transmitted by the product information transmission unit 2080 is displayed on the electronic shelf label 3000.

Here, a timing when the first instruction unit 2100 or the second instruction unit 2120 operates is not limited to the timing illustrated in FIG. 16. For example, in a case where the product information transmission unit 2080 transmits the product information to the plurality of electronic shelf labels 3000, the second instruction unit 2120 may operate after the product information transmission unit 2080 finishes to transmit the product information to all the electronic shelf labels 3000.

### Exemplary Embodiment 4

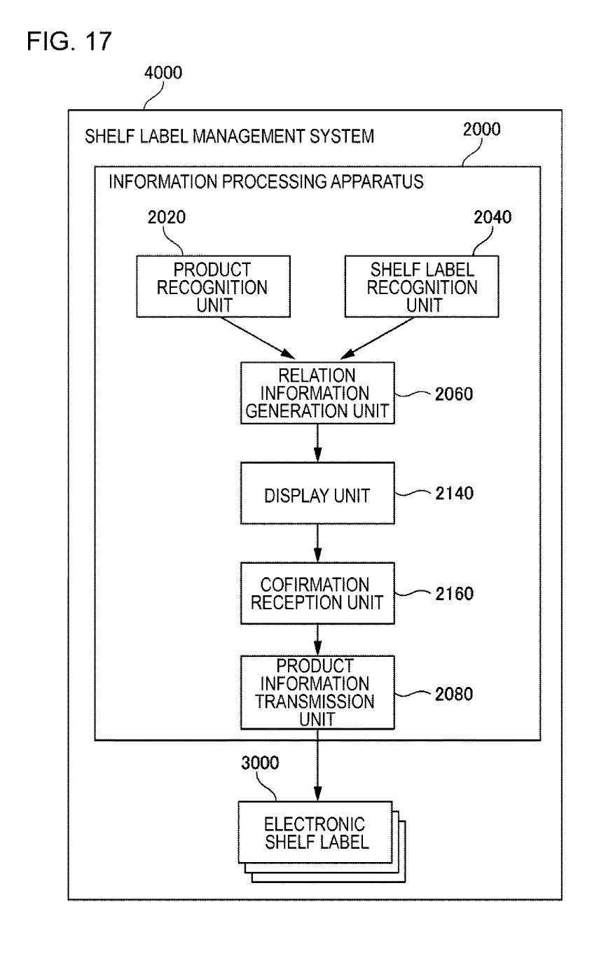

FIG. 17 is a block diagram illustrating an information processing apparatus 2000 according to Exemplary Embodiment 4. In FIG. 17, arrows represent information flows. In FIG. 17, each block does not depict a configuration of a hardware unit but a configuration of a functional unit. Except for the following description, the information processing apparatus 2000 of Exemplary Embodiment 4 has the same configuration as that of the information processing apparatus 2000 of Exemplary Embodiment 2 or 3.

The information processing apparatus 2000 of Exemplary Embodiment 4 receives a confirmation of whether or not the relation information generated by the relation information generation unit 2060 is correct. The information processing apparatus 2000 transmits the product information to the electronic shelf label 3000 by using the relation information having been confirmed to be correct.

To do so, the information processing apparatus 2000 of Exemplary Embodiment 4 includes a display unit 2140, and a confirmation reception unit 2160. The display unit 2140 displays the relation information. The confirmation reception unit 2160 receives a confirmation indicating that the association indicated by the relation information is correct. The product information transmission unit 2080 of Exemplary Embodiment 4 transmits the product information by using the relation information having been confirmed that the association is correct. Here, the electronic shelf label 3000 of a transmission destination is the electronic shelf label 3000 having the shelf label ID indicated by the relation information having been confirmed that the association is correct. The transmitted product information is the product information indicated by this relation information.

<Format of Display Performed by Display Unit 2140>

For example, the display unit 2140 displays the relation information table 300 illustrated in FIG. 8. The confirmation reception unit 2160 receives an input of whether or not the relation information represented in each row is correct, for each row of the relation information table 300. Note that, the display unit 2140 may output the relation information table 300 as a file.

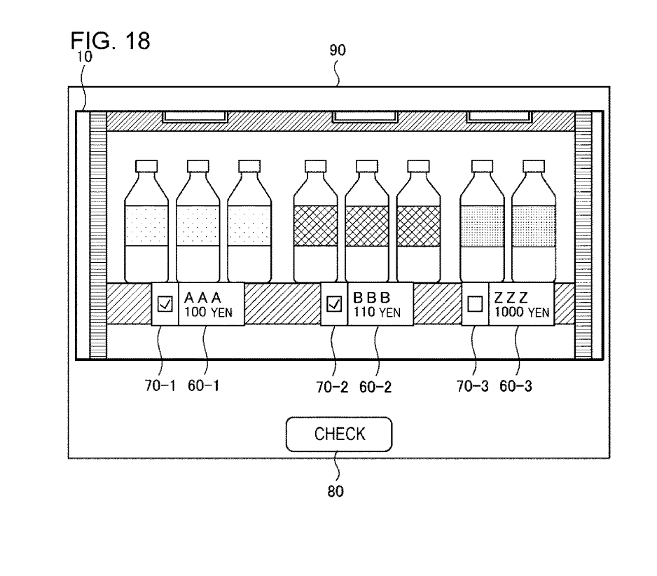

In another example, the display unit 2140 may display the relation information by using the target image. Specifically, the display unit 2140 displays, near each electronic shelf label 3000 on the target image or the like, the product information associated with the electronic shelf label 3000. FIG. 18 is a diagram illustrating a case where the relation information is displayed on the target image 10. FIG. 18 illustrates the screen 90 displayed on the display unit 2140. The screen 90 includes the target image 10 and a check button 80. Note that, the screen 90 is displayed on the display screen of the terminal operated by the salesperson.

The target image 10 of FIG. 18 illustrates the same situation as that shown by the target image 10 of FIG. 4. Here, on the target image 10 of FIG. 18, product information 60 associated with the electronic shelf label 3000 is displayed in the position in which the electronic shelf label 3000 is displayed on the target image 10 of FIG. 4. Here, the position of each electronic shelf label 3000 on the target image 10 is recognized by the shelf label recognition unit 2040. Thus, the display unit 2140 can use this position to determine the position in which the product information 60 is to be displayed.

By displaying the product information 60 so as to be superimposed on the electronic shelf label 3000 as stated above, the salesperson who sees the screen 90 can virtually see the result of transmitting the product information 60 to the electronic shelf label 3000. Thus, the salesperson easily and intuitively confirm whether or not the product information 60 is correct by comparing the product information 60 with the product 40.

In FIG. 18, a check box 70 is displayed on the left of each product information item 60. The salesperson adds the check mark in the check box 70 next to the product information 60 having the correct content. In FIG. 18, the check marks are added in a check box 70-1 and a check box 70-2. On the other hand, the check mark is not added in a check box 70-3. These check marks represent that it is determined that “the product information 60-1 and the product information 60-2 are correct but the product information 60-3 is not correct”. The salesperson finally ends the input by pressing the check button 80.

In a case where the check button 80 is pressed, the confirmation reception unit 2160 acquires the state of each check box 70. The confirmation reception unit 2160 determines that the input indicating that “the association is correct” is performed on the relation information indicating the product information 60 for which the check mark is added in the check box 70. By displaying the check box 70 that is an input interface on the confirmation reception unit 2160 next to the product information 60 as stated above, the salesperson can easily and intuitively input the result of confirmation of the relation information.

<Display Location Performed by Display Unit 2140>

There are various locations to which the display unit 2140 outputs the aforementioned display. For example, the display unit 2140 outputs the aforementioned display on a display screen connected to the information processing apparatus 2000. In another example, the display unit 2140 may output the aforementioned display on the display screen of the portable terminal used by the salesperson. In this case, the portable terminal is connected to the computer 5000 through, for example, a network line. The display unit 2140 transmits the aforementioned display to the portable terminal through this network line.

<Input Method to Confirmation Reception Unit 2160>

The input method to the confirmation reception unit 2160 is, for example, a method using the aforementioned check box. In another example, in a case where the display unit 2140 outputs the relation information as the file, the confirmation reception unit 2160 may receive the file to which the information of whether or not each of relation information is correct is added, as the input.

In another example, in a case where the display unit 2140 displays the relation information on the display screen connected to the information processing apparatus 2000, the input to the confirmation reception unit 2160 is performed through an input device such as a keyboard connected to the information processing apparatus 2000. On the other hand, in a case where the display unit 2140 transmits the display to the portable terminal of the salesperson, the input to the confirmation reception unit 2160 is performed through the input device of this portable terminal. The information input to the portable terminal is transmitted to the information processing apparatus 2000 through the aforementioned network line.

<Flow of Processes>

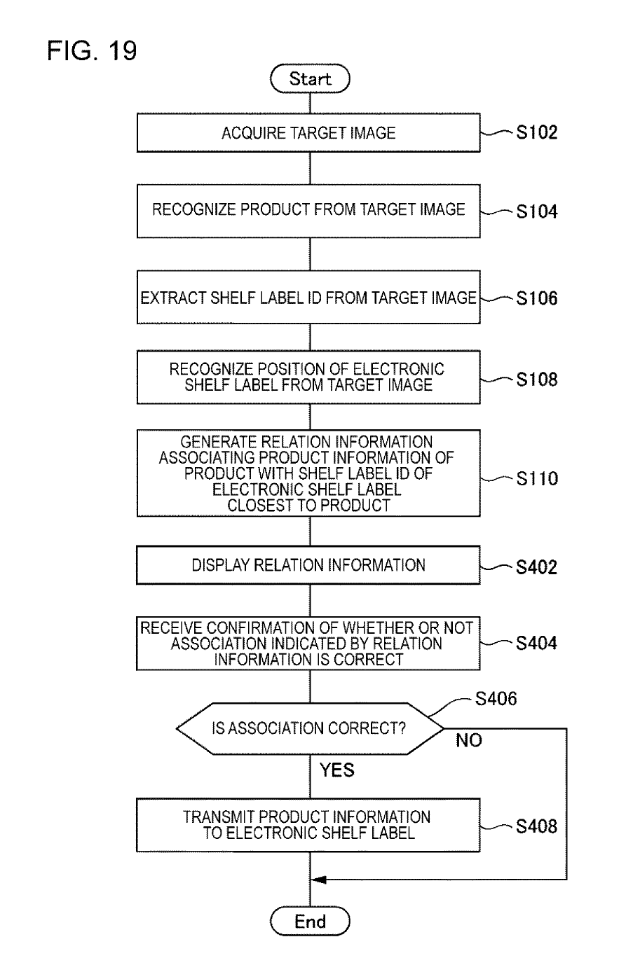

FIG. 19 is a flowchart illustrating a flow of processes performed by the information processing apparatus 2000 of Exemplary Embodiment 4. Here, the processes in steps S102 to S110 of FIG. 19 are the same as the processes performed in steps S102 to S110 of FIG. 2. Thus, the description of these processes will not be repeated.

After step S110 is performed, the display unit 2140 displays the relation information (S402). The confirmation reception unit 2160 receives a confirmation of whether or not the association indicated by the relation information is correct (S404). In a case where it is input that the association indicated by the relation information is correct (S406: YES), the process of FIG. 19 proceeds to step S408. In step S408, the product information transmission unit 2080 transmits the product information to the electronic shelf label 3000. On the other hand, in a case where it is not input that the association indicated by the relation information is correct (S406: NO), the process of FIG. 19 is ended.

According to the present exemplary embodiment, the product information indicated by the relation information having been confirmed to be correct is transmitted to the product information transmission unit 2080. Thus, it is possible to prevent the incorrect product information from being displayed on the electronic shelf label 3000 in a case where relation information is incorrect.

### Exemplary Embodiment 5

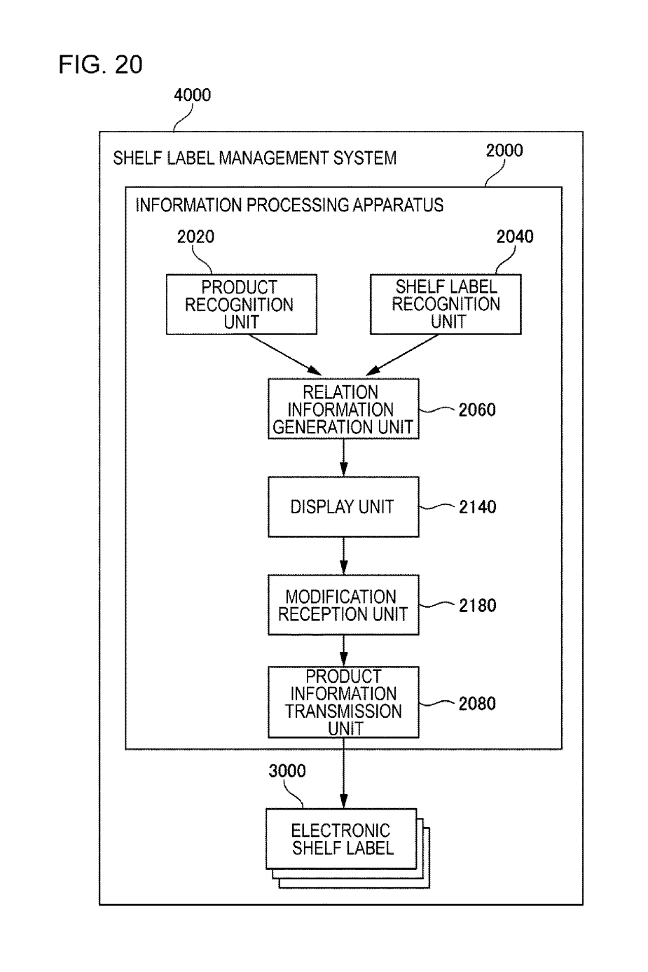

FIG. 20 is a block diagram illustrating an information processing apparatus 2000 according to Exemplary Embodiment 5. In FIG. 20, arrows represent information flows. In FIG. 20, each block does not depict a configuration of a hardware unit but a configuration of a functional unit. Except for the following description, the information processing apparatus 2000 of Exemplary Embodiment 5 has the same configuration as that of the information processing apparatus 2000 of Exemplary Embodiment 3 or Exemplary Embodiment 4.

The information processing apparatus 2000 of Exemplary Embodiment 5 displays the relation information generated by the relation information generation unit 2060, and receives a modification of the relation information. The information processing apparatus 2000 transmits the product information based on the modified relation information.

To do so, the information processing apparatus 2000 of Exemplary Embodiment 5 includes a display unit 2140, and a modification reception unit 2180. The display unit 2140 is the same functional configuration unit as the display unit 2140 of Exemplary Embodiment 4. The modification reception unit 2180 receives the modification of the relation information displayed by the display unit 2140. The product information transmission unit 2080 transmits the product information by using the modified relation information. Here, the electronic shelf label 3000 of the transmission destination is the electronic shelf label 3000 having the shelf label ID indicated by the modified relation information. The transmitted product information is the product information indicated by the relation information.

<Input Method to Modification Reception Unit 2180>

For example, in the information processing apparatus 2000 of Exemplary Embodiment 5, the display unit 2140 displays on the display screen an image showing the target image on which the product information 60 is displayed, similarly to the display unit 2140 of Exemplary Embodiment 4. Here, in Exemplary Embodiment 5, the character string displayed on each of product information 60 of FIG. 15 can be changed by a key input. The modification reception unit 2180 receives the change of the content of the product information 60, as the modification of the relation information.

If the confirmation and modification of the relation information is finished, the salesperson presses the check button 80. Thereafter, the modification reception unit 2180 acquires the content of the modification of the product information 60 input on the screen 90. The modification reception unit 2180 modifies the relation information based on the acquired content.

Here, the modification method of the relation information is not limited to the aforementioned method. In another example, in a case where the display unit 2140 displays the relation information on the display screen in a table format, the modification reception unit 2180 receives the modification of this table. In another example, in a case where the display unit 2140 outputs and displays the relation information as the file, the modification reception unit 2180 may receives the input of the file the content of which is modified.

<Flow of Processes>

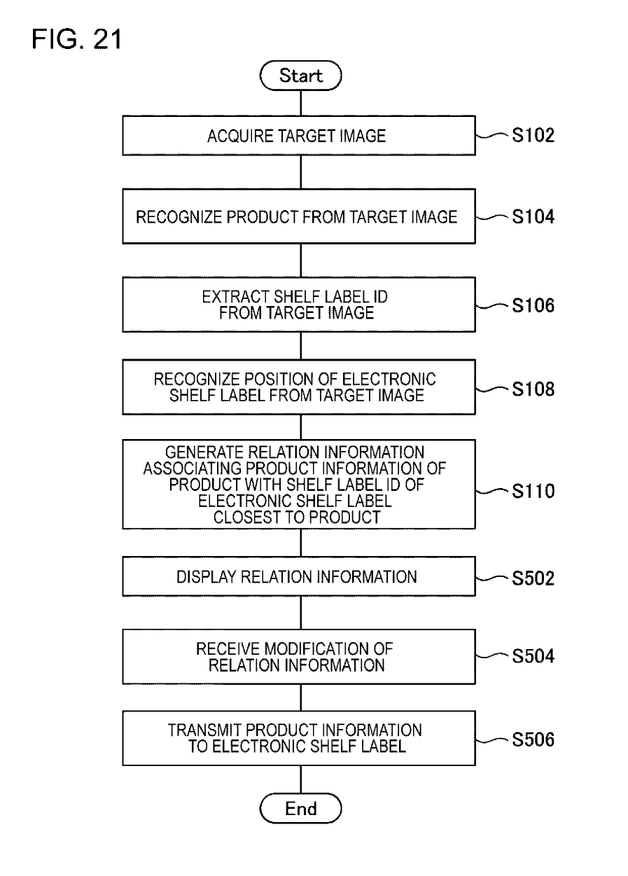

FIG. 21 is a flowchart illustrating a flow of processes performed by the information processing apparatus 2000 of Exemplary Embodiment 5. Here, the processes in steps S102 to S110 of FIG. 21 are the same as the processes performed in steps S102 to S110 of FIG. 2. Thus, the description of these processes will not be repeated.

After step S110 is performed, the display unit 2140 displays the relation information (S502). The modification reception unit 2180 receives the modification of the relation information (S504). The product information transmission unit 2080 transmits the product information (step S506). Here, in a case where the relation information is not modified in step S504, the product information indicated by the relation information generated by the relation information generation unit 2060 is transmitted without modification.

According to the present exemplary embodiment, it is possible to modify the relation information the association of which is incorrect. Thus, even in a case where the relation information generated by the relation information generation unit 2060 has an error, it is possible to display the correct product information on the electronic shelf label 3000 by modifying this error.

### Modification Example

The information processing apparatus 2000 of Exemplary Embodiment 5 may include the confirmation reception unit 2160 similarly to the information processing apparatus 2000 of Exemplary Embodiment 4. In this case, for example, the modification reception unit 2180 receives the modification to the relation information for which the confirmation reception unit 2160 receives the input of “the association is not correct”. The product information transmission unit 2080 transmits both 1) the product information having been confirmed to be correct and 2) the modified product information. Here, it is considered that the non-modified product information among the product information for which “the association is not correct” is input may be the incorrect product information. Thus, the product information transmission unit 2080 does not transmit this product information.

Although the exemplary embodiments of the present invention have been described with reference to the drawings, these exemplary embodiments are examples of the present invention, and the combinations of the exemplary embodiments and various configurations other than the exemplary embodiments may be adopted.

Hereinafter, reference examples are appended.

1. An information processing apparatus comprising:
a product recognition unit recognizing a product from an image on which the product and an electronic shelf label are imaged;
a shelf label recognition unit extracting a shelf label ID of the electronic shelf label from the image, and recognizing a position of the electronic shelf label; and
a relation information generation unit generating relation information that associates product information of the recognized product with the shelf label ID of the recognized electronic shelf label closest to the product, based on a position of the recognized product and the position of the recognized electronic shelf label.

2. The information processing apparatus according to 1, further comprising:
a product information transmission unit transmitting the product information associated with the electronic shelf label in the relation information, to the electronic shelf label.

3. The information processing apparatus according to 2, further comprising:
a first instruction unit transmitting to the electronic shelf label an instruction to switch from a first mode to a second mode, information of the product being displayed in the first mode, the shelf label ID being displayed on the second mode; and
a second instruction unit transmitting to the electronic shelf label an instruction to switch from the second mode to the first mode.

4. The information processing apparatus according to 3, further comprising:
a display unit displaying the relation information; and
a confirmation reception unit receiving a confirmation of whether or not association indicated by the relation information is correct,
wherein the product information transmission unit transmits the product information to the electronic shelf label having the shelf label ID indicated by the relation information for which the association is confirmed to be correct.

5. The information processing apparatus according to 3, further comprising:
a display unit displaying the relation information; and
a modification reception unit receiving a modification of association indicated by the relation information,
wherein the product information transmission unit transmits the product information to the electronic shelf label having the shelf label ID indicated by the modified relation information.

6. A shelf label management system that includes the information storage apparatus according to any one of 1 to 5 and an electronic shelf label,
wherein the electronic shelf label includes a display unit displaying the product information associated with the shelf label ID of the electronic shelf label.

7. The shelf label management system according to 6,
wherein the display unit included in the electronic1 shelf label displays a plurality of pieces of product information in a simultaneous or time-division manner in a case where the respective pieces of product information are associated with the shelf label ID of the electronic shelf label.

8. A control method performed by a computer, the method comprising:
a product recognition step of recognizing a product from an image on which the product and an electronic shelf label are imaged;
a shelf label recognition step of extracting a shelf label ID of the electronic shelf label from the image, and recognizing a position of the electronic shelf label; and
a relation information generation step of generating relation information that associates product information of the recognized product with the shelf label ID of the recognized electronic shelf label closest to the product, based on a position of the recognized product and the position of the recognized electronic shelf label.

9. The control method according to 8, further including a product information transmission step of transmitting the product information associated with the electronic shelf label in the relation information, to the electronic shelf label.

10. The control method according to 9, further including:
a first instruction step of transmitting to the electronic shelf label an instruction to switch from a first mode to a second mode, information of the product being displayed in the first mode, the shelf label ID being displayed on the second mode; and
a second instruction step of transmitting to the electronic shelf label an instruction to switch from the second mode to the first mode.

11. The control method according to 10, further including:
a display step of displaying the relation information; and
a confirmation reception step of receiving a confirmation of whether or not association indicated by the relation information is correct,
wherein, in the product information transmission step, the product information is transmitted to the electronic shelf label having the shelf label ID indicated by the relation information for which the association is confirmed to be correct.

12. The information processing apparatus according to 10, further including:
a display step of displaying the relation information; and
a modification reception step of receiving a modification of association indicated by the relation information,
wherein, in the product information transmission step, the product information is transmitted to the electronic shelf label having the shelf label ID indicated by the modified relation information.

13. A program causing a computer to operate as the information processing apparatus according to any one of 1to 5.
